(19) United States
(12) Patent Application Publication
(10) Pub. No.: US 2006/0287910 A1
(43) Pub. Date: Dec. 21, 2006

(54) Scenario analysis methods, scenario analysis devices, articles of manufacture, and data signals

(76) Inventors: Olga Anna Kuchar, Richland, WA (US); George Chin JR., Richland, WA (US); Paul Whitney, Richland, WA (US); Mary Powers, Richland, WA (US); Katherine E. Wolf, Richland, WA (US)

Correspondence Address: WELLS ST. JOHN P.S., 601 W. FIRST AVENUE, SUITE 1300, SPOKANE, WA, 99201, US

(21) Appl. No.: 11/158,448

(22) Filed: Jun. 21, 2005

(51) Int. Cl. G06Q 99/00; G07G 1/00; G06F 17/30

(52) U.S. Cl. 705/10; 705/1

(57) ABSTRACT

Scenario analysis methods, scenario analysis devices, articles of manufacture, and data signals are described according to some aspects. In one aspect, a scenario analysis method includes accessing a representation of a first scenario, accessing a plurality of representations of a plurality of second scenarios, analyzing the representation of the first scenario with respect to the representations of the second scenarios, determining a plurality of relationships of the representation of the first scenario with respect to respective ones of the representations of the second scenarios responsive to the analyzing, and ranking the relationships.

### GOVERNMENT RIGHTS STATEMENT

This invention was made with Government support under Contract DE-AC0676RL01830 awarded by the U.S. Department of Energy. The Government has certain rights in the invention.

### TECHNICAL FIELD

This invention relates to scenario analysis methods, scenario analysis devices, articles of manufacture, and data signals.

### BACKGROUND

There is increased interest and importance for providing improved techniques and systems for processing data for use by analysts. For example, analysts may over time observe numerous fact patterns and attempt to associate different fact patterns or portions of different fact patterns with one another in an attempt to gain further insight into unknown facts or circumstances related to a factual situation being analyzed.

Analysis of different factual situations may be used by law enforcement and related agencies when trying to understand more about situations wherein facts are missing, for example, when trying to solve crimes or predict future acts. More recently, there has been an increased focus upon analysis of past situations in an attempt to gain insight into acts which may occur in the future. For example, analysts may analyze a plurality of past terrorist attacks in an attempt to gain information of how, when and/or where (or any other related information) an attack may occur in the future. At least some aspects of the disclosure include improved methods, apparatus, articles of manufacture and data signals for use in analyzing factual situations.

### BRIEF DESCRIPTION OF THE DRAWINGS

Preferred embodiments of the invention are described below with reference to the following accompanying drawings.

FIG. 1 is an illustrative representation of a computing device according to one embodiment.

FIG. 2 is a functional block diagram of components of an exemplary computing device according to one embodiment.

FIG. 3 is an illustrative representation of a scenario according to one embodiment.

FIG. 4 illustrates a plurality of defined patterns which may be used for analysis of a scenario according to one embodiment.

FIG. 5 is a flow chart of an exemplary method of analyzing a scenario according to one embodiment.

FIG. 6 is an illustrative representation of exemplary analysis of plural analytical signatures according to one embodiment.

FIG. 7 is an illustrative representation of a semantic net according to one embodiment.

FIG. 8 is a flow chart depicting an exemplary method for analyzing a plurality of scenarios according to one embodiment.

### DETAILED DESCRIPTION

Attention is directed to the following commonly assigned application entitled “Scenario Representation Manipulation Methods, Scenario Analysis Devices, Articles Of Manufacture, And Data Signals”, listing Paul Whitney, McLean Sloughter, George Chin, Jr., Olga Anna Kuchar, Katherine E. Johnson, and Mary Powers as inventors, having Docket No. 14356-E, filed the same day as the present application, and which is incorporated herein by reference.

According to one aspect of the disclosure, a scenario analysis method comprises accessing a representation of a first scenario, accessing a plurality of representations of a plurality of second scenarios, analyzing the representation of the first scenario with respect to the representations of the second scenarios, providing a plurality of relationships of the representation of the first scenario with respect to respective ones of the representations of the second scenarios responsive to the analyzing, and ranking the relationships.

According to another aspect of the disclosure, a scenario analysis method comprises accessing an initial quantity of information regarding a scenario of interest, accessing a plurality of known scenarios, analyzing the scenario of interest with respect to individual ones of the known scenarios using processing circuitry, and gaining additional information regarding the scenario of interest in addition to the initial quantity of information responsive to the analyzing.

According to yet another aspect of the disclosure, a scenario analysis device comprises processing circuitry configured to access data regarding a scenario of interest, to access respective data regarding a plurality of known scenarios, to analyze the data of the scenario of interest with respect to respective data of individual ones of the known scenarios, and to identify one of the known scenarios as being of increased relevance to the scenario of interest compared with an other of the known scenarios responsive to the analysis.

According to another aspect of the disclosure, a scenario analysis device comprises processing circuitry configured to access data regarding a scenario of interest and a plurality of known scenarios, wherein the data comprises a plurality of labels of the scenario of interest and the known scenarios, wherein the processing circuitry is configured to analyze the labels of the scenario of interest with respect to the labels of the known scenarios to generate a plurality of semantic similarity values indicative of semantic similarities of the labels of the scenario of interest with respect to the labels of the known scenarios.

According to an additional aspect of the disclosure, an article of manufacture comprises media comprising programming configured to cause processing circuitry to perform processing comprising accessing a first scenario, accessing a plurality of second scenarios, analyzing the first scenario with respect to the plurality of second scenarios, and providing a plurality of similarity measures indicative of similarities of the second scenarios with respect to the first scenario responsive to the analyzing, wherein the similarity measures indicates that one of the second scenarios is of increased similarity to the first scenario compared with the similarity of an other of the second scenarios with respect to the first scenario.

According to still yet another aspect of the disclosure, a data signal embodied in a transmission medium comprises programming configured to cause processing circuitry to access data regarding a scenario of interest, access data regarding a plurality of known scenarios, analyze the data of the scenario of interest with respect to respective data of individual ones of the known scenarios, and identify one of the known scenarios as being of increased relevance to the scenario of interest compared with an other of the known scenarios responsive to the analysis.

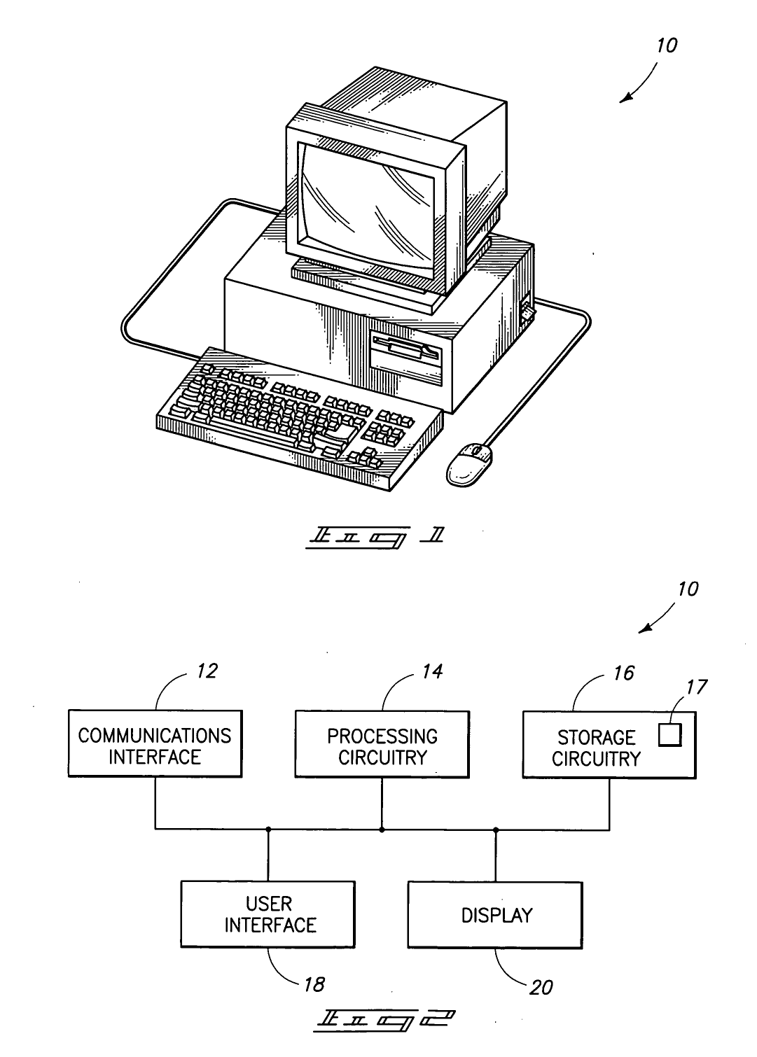

Referring to FIG. 1, an exemplary computing device 10 is illustrated. Computing device 10 may be implemented as a personal computer, workstation, or any suitable processing device configured to process digital data, user input, and/or other information.

Computing device 10 may be referred to as a scenario analysis device in one embodiment. A scenario may comprise information regarding objects (e.g., people, events, entities, etc.) and relationships of the objects with one another, with the environment and/or other associations. Scenarios may incorporate temporal relationships among information elements as well as spatial, logical and categorical relationships. Scenarios may be analyzed for various reasons including for purposes to gain knowledge which was previously unknown in some embodiments. For example, analysts in law enforcement or homeland security may analyze scenarios in an effort to identify plans may which be carried out at some point in time in the future (e.g., terrorism). Additional details regarding exemplary operations of computing device 10 to analyze and manipulate scenarios are described below.

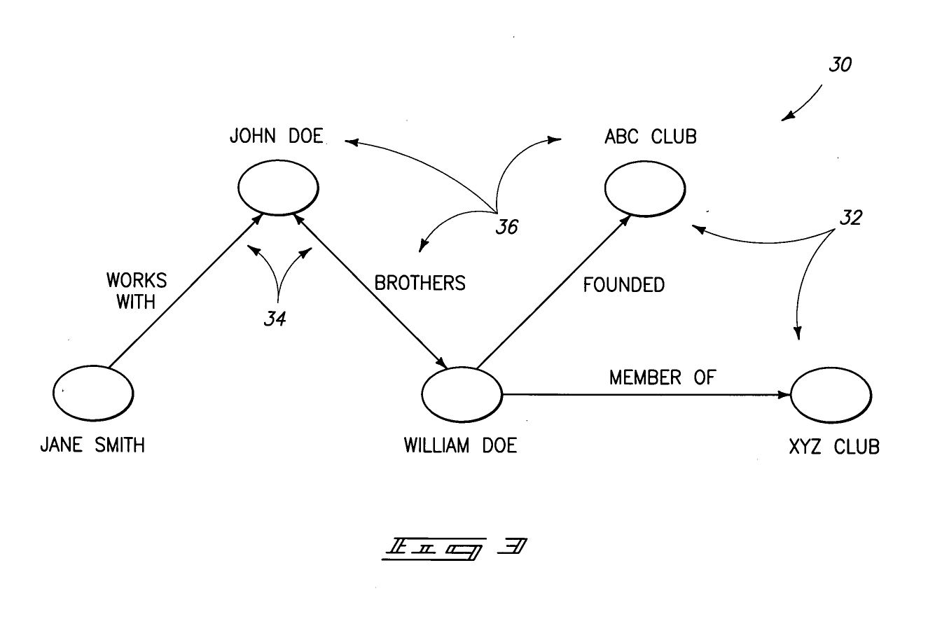

Referring to FIG. 2, components of a computing device 10 configured according to one embodiment are shown. The exemplary device 10 includes a communications interface 12, processing circuitry 14, storage circuitry 16, user interface 18 and a display 20. Other arrangements are possible including more, less and/or alternative components.

Communications interface 12 is arranged to implement communications of computing device 10 with respect to external devices (not shown). For example, communications interface 12 may be arranged to communicate information bi-directionally with respect to computing device 10. Communications interface 12 may be implemented as a network interface card (NIC), serial or parallel connection, USB port, Firewire interface, flash memory interface, floppy disk drive, or any other suitable arrangement for communicating data with respect to computing device 10.

In one embodiment, processing circuitry 14 is arranged to process data, control data access and storage, issue commands, and control other desired operations. Processing circuitry may comprise circuitry configured to implement desired programming provided by appropriate media in at least one embodiment. For example, the processing circuitry may be implemented as one or more of a processor and/or other structure configured to execute executable instructions including, for example, software and/or firmware instructions, and/or hardware circuitry. Exemplary embodiments of processing circuitry include hardware logic, PGA, FPGA, ASIC, state machines, and/or other structures alone or in combination with one or more processor. These examples of processing circuitry 14 are for illustration and other configurations are possible.

Storage circuitry 16 is configured to store electronic data and/or programming such as executable code or instructions (e.g., software and/or firmware), data, databases, or other digital information and may include processor-usable media. Processor-usable media includes any computer program product or article of manufacture 17 which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

As mentioned above, at least some embodiments or aspects described herein may be implemented using programming stored within appropriate storage circuitry described above and/or communicated via a network or using other transmission medium and configured to control appropriate processing circuitry. For example, programming may be provided via appropriate media including for example articles of manufacture, embodied within a data signal (e.g., modulated carrier wave, data packets, digital representations, etc.) communicated via an appropriate transmission medium, such as a communication network (e.g., the Internet and/or a private network), wired connection and/or electromagnetic energy for example via a communications interface, or provided using other appropriate communication structure or medium. Exemplary programming including processor-usable code may be communicated as a data signal embodied in a carrier wave in but one example.

User interface 18 is configured to interact with a user including receiving inputs from the user (e.g., tactile input, voice instruction, etc.) for example via a keyboard, mouse, microphone, etc. Any other suitable apparatus for interacting with a user may also be utilized.

Display 20 is configured to depict visual information to a user. In exemplary embodiments, display 20 is arranged as a cathode ray tube monitor, LCD monitor, etc.

In an exemplary arrangement configured as a scenario analysis device, the computing device 10 is configured to access representations of scenarios. In one embodiment, scenarios may be represented graphically to illustrate objects and associations or relationships of the objects. As discussed below, computing device 10 may analyze and manipulate representations of scenarios.

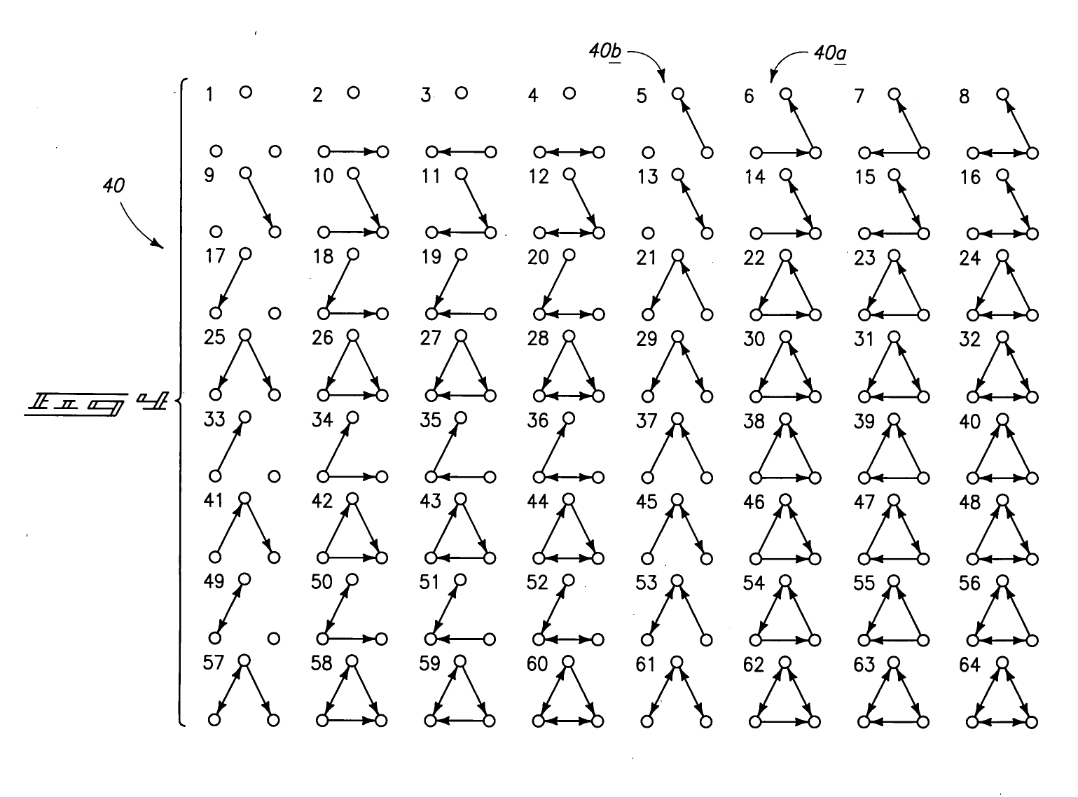

Referring to FIG. 3, an exemplary graphical representation 30 of a scenario is depicted. Exemplary existing programming applications which may be used to generate graphical representations 30 of scenarios include Analyst's Notebook, Watson, VisuaLinks, and Starlight. These applications enable convenient representation of objects and associations of objects of a scenario for observation, discussion, and/or analysis by an analyst.

The graphical representation 30 of FIG. 3 illustrates a plurality of objects represented as nodes 32 and a plurality of links or edges 34 which illustrate associations of the objects with one another (if appropriate) providing structural information regarding an arrangement of nodes 32. Individual nodes 32 may have associations with one or more other nodes 32 as represented by edges 34 in the depicted example. Further, associations of nodes 32 may be directional (e.g., one or both directions) as represented by edges 34 in the form of arrows. Exemplary objects include people, places, communications, entities, organizations or any other object which may be associated with other objects of the scenario being represented. Nodes 32 of a graphical representation 30 of a scenario may be referred to as scenario nodes. Exemplary illustrated associations may include relationships (e.g., familial, acquaintances, employment, etc.), hierarchies, financial transactions, meetings or other associations otherwise capable of being represented. In one embodiment, labels 36 may be associated with nodes 30 and/or links 32 to identify the respective objects and associations. In addition, nodes 32 or edges 34 may include other information regarding an object or association of objects in addition to what is represented by labels 36. For example, if a label 36 of node 32 is a name of an individual, the node 32 may also include other information regarding the individual, such as citizenship, residence, etc. although not shown in the label 36. The illustrated graphical representation 30 is merely for discussion purposes and other variants are possible.

Once created, graphical representations and/or files of graphical representations 30 may be organized and filed for later use. For example, the graphical representations 30 and/or files may be filed in a case library (e.g., using storage circuitry 16, an external database, etc.). During review of other scenarios at subsequent moments in time, an analyst may recall similarities to previously analyzed and filed scenarios, and accordingly, attempt to locate the desired representations of the scenarios. For example, the previously stored or analyzed scenarios may have objects and/or associations of objects which are similar to a scenario being analyzed and may provide insight into the analysis of the current scenario.

Once the desired scenarios are identified, the analysts may analyze the identified scenarios with respect to the current scenario in an attempt to identify similarities or gain insight or leads into the current scenario being studied. However, challenges are presented by attempts to locate previously filed graphical representations 30 of scenarios inasmuch as significant amounts of time are used to search using graphical search techniques which may attempt to identify relevant graphical representations stored in a database by matching them to a current graphical representation of the scenario being analyzed using graph processing programs which analyze the graphics. More specifically, it is not uncommon for graphical representations 30 to be significantly larger than the example of FIG. 3 including numerous additional nodes 30 and associations of nodes 32 which further complicates and/or slows searching of the scenarios. At least some aspects of the disclosure provide systems and methods which facilitate searching of graphical representations of scenarios.

More specifically, in exemplary embodiments, methods and apparatus (e.g., computing device 10) are arranged to use initial (e.g., graphical) representations of scenarios to generate additional representations of the scenarios to facilitate processing (e.g., searching and identification) of the scenarios at later moments in time. For example, the newly generated representations of the scenarios may be used to reduce the searching and processing time performed to identify previously generated and stored scenarios which may have similar aspects to a scenario being studied. Following identification of scenarios of interest using the generated representations, the respective graphical representations of the scenarios may be accessed and utilized for further analysis with respect to the subject scenario being analyzed or for other purposes.

According to one embodiment, aspects of the disclosure provide generation of additional representations of the scenarios using the graphical representations 30 of the scenarios. In one implementation, the additional representations of the scenarios are analytical signatures comprising mathematical representations (e.g., vectors) of graphical structural arrangements of scenarios. As described below according to one exemplary embodiment, the computing device 10 may develop the analytical signatures comprising signature vectors which capture salient features of the respective scenarios. In a more specific example, exemplary signature vectors are mathematical structures based on n-ary relations with allowances for missing information and highly labeled directed graphs in one arrangement. In one embodiment, the analytical signatures include numeric representations which represent structure information of the graphical representations 30 of the scenarios and may be constructed at the graph and/or node level. The signature vectors may include information regarding structure of relationships of the objects and/or content of the relationships or associations of the objects with one another.

In one embodiment, a plurality of features or patterns of a graphical representation 30 may be used to generate a different representation of the scenario represented by the graphical representation 30. According to one implementation, computing device 10 may be configured to determine the presence of different features or patterns within the graphical representation 30 to generate a different representation of a scenario comprising a signature vector.

Referring to FIG. 4, a plurality of exemplary defined patterns 40 which may be used to provide additional representations of scenarios represented graphically are shown. The defined patterns 40 are unique structural arrangements individually including a plurality of nodes and association(s) of the nodes. The nodes of defined patterns 40 may be referred to as pattern nodes. The exemplary defined patterns 40 in one embodiment include triads individually comprising three nodes and association(s) of the nodes. In such an embodiment, a numeric signature vector of length 2⁶=64 could be constructed based on the occurrence of 64 triad patterns. Other types of patterns may be used in other embodiments.

In one embodiment, the graphical representation of a subject scenario being studied may be analyzed with respect to the defined patterns 40. For example, in one embodiment, for each of the defined patterns 40, a number (also referred to as a coordinate) is provided corresponding to the number of times the respective defined pattern 40 occurs in the graphical representation 30. According to the described embodiment, sixty-four exemplary triads are shown, and sixty-four different numbers or coordinates may be generated responsive to the analysis of a given graphical representation 30 and individually corresponding to the number of times the respective defined pattern 40 occurs in the graphical representation. The numbers of occurrences are global characteristics of the graphical representation 30. In one exemplary embodiment, the numbers of occurrences may be used to formulate the analytical signature comprising a mathematical representation of a scenario. The mathematical representation may comprise a numeric signature vector which is indicative of the respective graphical representation 30 and captures salient structural features of the graphical representation 30 being analyzed.

In one implementation, the ascertained numbers of the respective patterns 40 may be modified to assure that the signature representation of the scenario generated from the graphical representation 30 is sub-graph preserving. Sub-graph preserving operations result in measures that do not change significantly if a piece of a graph is added or deleted. For example, in one implementation, the presence of one pattern 40 increments the number or count for the respective pattern 40 as well as the number(s) of the pattern(s) 40 which include the respective pattern 40 to implement subgraph preserving operations. In the example of FIG. 4, the presence of pattern 40b in a graphical representation 30 will result in the numbers of both patterns 40a, 40b being incremented (i.e., pattern 40a includes pattern 40b or in other words pattern 40b is a sub-graph of pattern 40a) by processing circuitry 14.

Other potentially useful measures on graphs and nodes of graphs in addition to defined patterns 40 may additionally be used to generate additional representations of a scenario. Exemplary additional measures include: degrees of nodes (i.e., the number of edges attached to a node and/or the type of edges entering or leaving the node wherein global measures may be constructed based on a distribution of the degree over the nodes in the graph), gamma index (i.e., the number of observed edges compared with a total number of possible edges—a measure of connectivity), clustering coefficient of a node (e.g., the proportion of nodes connected with a given node that are connected with each other), the order or size of a graph (e.g., the number of nodes and/or edges), connectedness (e.g., whether two particular nodes or node types are connected), number of connected sub-graphs or patterns, and/or the occurrence of particular sub-patterns as described in “Social Network Analysis: Methods and Applications”, Wasserman et al., Cambridge University Press, 1994 and “Algebraic Models for Social Networks”, Philippa Pattison, Cambridge, 1993, the teachings of both articles are incorporated herein by reference and which describe that particular patterns of triads may be used as characteristics of social networks. Descriptions of additional features are described in “Social Network Analysis: Methods and Applications”, Wasserman et al., Cambridge University Press, 1994, incorporated by reference above, and “Graph Theory Indexes and Measures”, Jean-Paul Rodrigue, http://people.hofstra.edu/geotrans/eng/ch2en/meth2en/ch2m2en. html, February 2004, the teachings which are incorporated herein by reference. The features utilized for generation of an additional representation of a graphical representation may be changed or varied dependent upon the objectives of the analysis.

Provision of a representation of a scenario in another format in addition to a graphical representation (e.g., vector) may facilitate further analysis of the scenario or other (e.g., related) scenarios. For example, vectors may be searched in a more straightforward manner compared with graphical searching techniques and may permit a relatively large number of scenarios to be searched in a relatively short period of time. Further, the amount of digital data of a vector representation of a scenario is typically significantly less than an amount of digital data for a graphical representation of the scenario while the vector representation retains information regarding the scenario (e.g., structural information regarding the nodes and associations of the nodes and which may further include label information of the nodes).

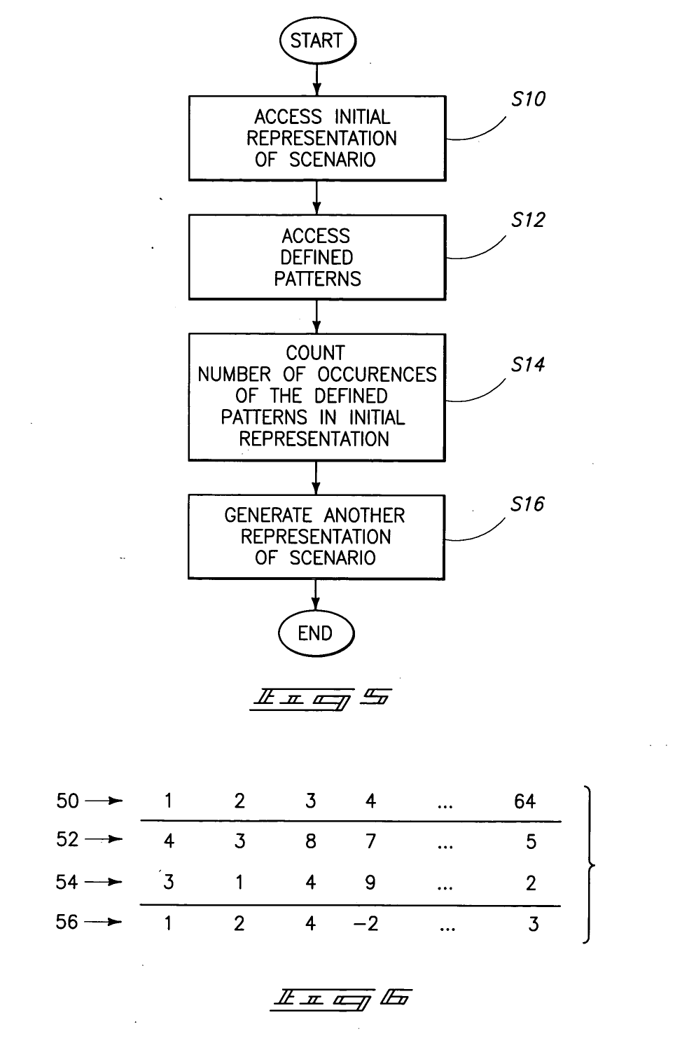

Referring to FIG. 5, an exemplary methodology for generating a new representation of a scenario from an initial representation of the scenario is shown. Processing circuitry 14 of computing device 10 may be arranged to implement the method in one embodiment to manipulate representations of a scenario. Other methods are possible including more, less and/or alternative steps.

At a step S10, the processing circuitry may access a file of an initial (e.g., graphical) representation of a scenario to be analyzed. In exemplary embodiments, files of initial representations of scenarios may be accessed from a communications interface or storage circuitry of the computing device. The initial representation may include a graphical representation of the scenario including both structural aspects (e.g., nodes, edges which indicate associations or links of the nodes) and labels of the nodes and/or edges.

At a step S12, the processing circuitry may access a list of defined patterns or structural arrangements of nodes and edges which may be used to analyze the graphical representation. In one embodiment, the defined patterns include different triad patterns.

At a step S14, the processing circuitry analyzes the graphical representation of the scenario by counting the number of occurrences of each of the defined patterns in the graphical representation. For example, the processing circuitry may access a given pattern, search for the presence of the respective pattern within the graphical representation by comparing the defined pattern with respect to arrangements of nodes and edges occurring in the graphical representation, and store the number of occurrences of the pattern within the graphical representation. This may be repeated for the other defined patterns. In one embodiment, the processing circuitry may increment a counted number of a pattern when a sub-graph of the respective pattern is counted to provide self-preserving aspects as mentioned above. In one more specific exemplary embodiment, for each group of three nodes within a graphical representation, the structure (i.e. defined triad pattern) is identified and the appropriate contents of the signature vector (e.g., coordinate) that reflect the 3-node group or triad may be incremented. Every different combination of 3-node groupings of the graphical representation 30 is considered for completeness of the analytical signature in one embodiment.

At a step S16, the processing circuitry generates the new representation of the scenario including a vector using the numbers determined in step S14. The new representation may be stored using storage circuitry and/or outputted using the communications interface in exemplary embodiments for subsequent use and analysis.

As described herein, at least some aspects of the disclosure provide methods and apparatus for representing a scenario or manipulating a representation of a scenario. In one implementation, a graphical representation of a scenario is converted to another representation, such as a vector, which includes numbers of occurrences of defined patterns present within the graphical representation being analyzed. The vector may be used in subsequent operations, for example, for comparison to other vectors to identify related or similar scenarios, or other analysis operations, for example using numeric data analysis routines. As described in further detail below, some aspects of the disclosure may be useful for summarizing a collection of scenarios, retrieval of similar scenarios for suggesting additional lines of investigation, or for finding “relation paths” between key actors of a given scenario. Other uses of the generated representations of scenarios are possible.

The above-described aspects include illustrative embodiments of generating representations of scenarios. As discussed below, computing device 10, for example operating as a scenario analysis device, may analyze a plurality of scenarios with respect to one another. For example, one scenario may be analyzed with respect to a plurality of other scenarios in an attempt to determine the respective similarities or relavences of the one scenario to the other scenarios. In but one example, a scenario of interest being analyzed by an analyst at a moment in time may be analyzed with respect to a plurality of known (e.g., previously generated) scenarios, for example stored as a scenario case library or database within storage circuitry 16 or otherwise accessed. Exemplary analysis aspects discussed herein may be useful for analysis of other scenarios in other embodiments. The analysis by computing device 10 may attempt to determine the relative relevance (e.g., similarity) of one scenario to other (e.g., different but perhaps related) scenarios.

In one illustrative embodiment, representations of the scenarios described above may be used to analyze a plurality of scenarios with respect to one another (e.g., representations of the scenario of interest and known scenarios). In one analysis methodology, one or more scenarios which are identified as relevant may be used to gain insight or additional previously unknown information regarding a scenario of interest. For example, a node may represent an object such as a person. An initial quantity of information may be available regarding the object from the scenario of interest (e.g., associations of the person with other people, businesses, groups, etc. as determined from information available from a scenario of interest). Analysis of the scenario of interest with respect to other (e.g., known) scenarios may enable analysts to gain additional knowledge regarding the scenario of interest (e.g., gain information regarding additional relationships of the object not discernable from the scenario of interest itself).

Initially, computing device 10 may access a scenario to be analyzed, which may be referred to as a scenario of interest as mentioned above. In exemplary embodiments, the scenario may be accessed by computing device 10 as a graphical representation of the scenario, as a mathematical representation (e.g., analytical signature representation in the form of vector) of the scenario as described above or in other form. Computing device 10 may generate an analytical signature representation of the scenario of interest if the accessed representation is in graphical or other form, for example, using aspects described above in one embodiment. Analytical signature representations may be provided to facilitate analysis of the scenarios including analysis of structural arrangements of the scenarios as described further below. Alternatively or in addition to structural analysis, computing device 10 may analyze semantic aspects of the scenarios as described further below.

The computing device 10 may analyze the scenario of interest with respect to known scenarios in one analysis embodiment to determine relationships between plural scenarios. For example, storage circuitry 16 may comprise a plurality of representations (e.g., analytical signature representations) of a plurality of known scenarios. In one embodiment, the processing circuitry 14 compares the analytical signature representations and/or semantic aspects of the scenario of interest and the known scenarios in order to determine relationships of how relevant individual ones of the known scenarios may be to the scenario of interest.

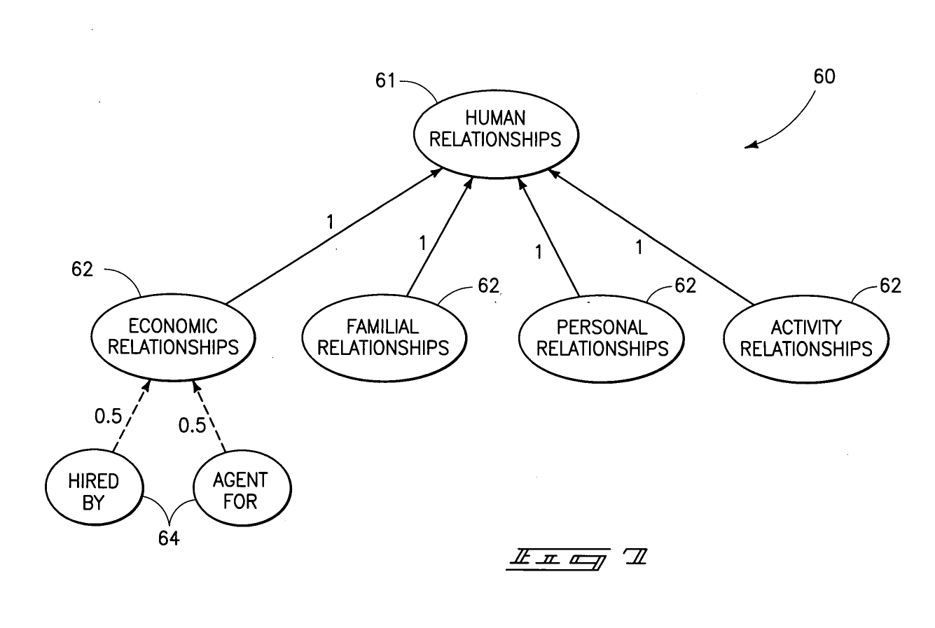

Referring to FIG. 6, an exemplary analysis performed by computing device 10 of a scenario of interest with respect to a known scenario is illustratively shown according to one embodiment. Although FIG. 6 is discussed with respect to a single known scenario, the illustrated process may be repeated using the scenario of interest with respect to other known scenarios in but one embodiment. FIG. 6 illustrates an exemplary process for analyzing structural arrangements of plural scenarios with respect to one another. For example, the analysis may be performed with respect to structural arrangements (e.g., defined patterns such as triads) of nodes of the respective scenarios as described in the exemplary embodiments above.

FIG. 6 illustrates a plurality of coordinates 50 from 1 to 64 in the illustrated embodiment. Coordinates 50 may correspond to sixty-four different defined patterns of nodes in the form of triads corresponding to FIG. 4 in the example of FIG. 6. Analytical signatures 52, 54 of a scenario of interest and a known scenario, respectively, are also shown. Individual ones of the analytical signatures 52, 54 include a plurality of coordinate values corresponding to the coordinates 50. In one embodiment, the coordinate values indicate the numbers of the occurrences of the respective different defined patterns (e.g., triads of nodes) in the respective scenarios being represented (e.g., the scenario of interest includes eight different occurrences of the third triad while the known scenario includes four different occurrences of the third triad in the example of FIG. 6). As mentioned above, sub-graph preserving techniques may be implemented in some embodiments and the coordinate values may indicate the number of occurrences of the respective graphs (e.g., triads) and sub-graphs thereof.

According to one analysis method, the processing circuitry 14 compares numbers of the respective defined patterns of the scenarios being analyzed with respect to one another. For example, in one comparison embodiment, processing circuitry 14 may subtract the respective coordinate values (i.e., numbers) of the known scenario 54 from the coordinate values (i.e., numbers) of the scenario of interest 52 yielding a comparison vector 56 comprising a plurality of similarity values for the respective coordinates 50 and indicative of the subtraction calculation. The comparison vector 56 includes all positive numbers in one embodiment. For example, negative coordinate values (e.g., the fourth coordinate value in FIG. 6) resulting from the subtraction may be set to zero in one embodiment.

Computing device 10 may sum or total the coordinate values of the comparison vector 56 yielding a structural similarity measure (not shown) which may indicate the relative similarity of the known scenario being compared with respect to the scenario of interest. The computing device 10 may additionally access analytical signatures of other known scenarios and calculate respective structural similarity measures for the other known scenarios using the example process of FIG. 6 in one embodiment. The structural similarity measures are indicative of similarities of structural arrangements of nodes of the scenario of interest with respect to structural arrangements of nodes of respective ones of the known scenarios in one embodiment. Smaller structural similarity measures indicate that the respective known scenarios may be considered to be more relevant than known scenarios having larger structural similarity measures in one embodiment. The difference between the analytical signatures of plural scenarios may be refereed to as a structural distance between the two scenarios and the structural distance corresponding to the structural similarity measure of the two scenarios in one embodiment may be calculated by:

$${d}_{structure} ( {G}_{1} , {G}_{2} ) = {\sum }_{i} {( {m}_{i} ( {G}_{i} ) - {m}_{i} ( {G}_{2} ) )}_{+} \qquad Eqn . A$$

where i is the number of defined patterns, m is the defined pattern or coordinate (e.g., triads) and G1 and G2 correspond to the respective values or numbers of the scenario of interest and the known scenario being compared for the respective defined pattern. In the above equation A, (x)+ denotes the “positive part” of x, that is max (0,x) and the structural distance between two graphs is zero when G1 is a sub-graph of G2 using sub-graph preserving measures. This measure is not a distance in a mathematical sense but provides a quick-screen for whether one graph might be a sub-graph of another as well as providing a metric on a degree of deviation. The computational complexity of the sub-graph screening evaluation using a triad signature and equation A is O(n³), where n is the larger of the number of nodes in G1 or G2. Also, the expensive part of the computational cost can be a one-time penalty in the case that the signature vectors are to be stored for subsequent analysis.

A structural similarity measure may also be obtained according to:

$$Structural Similarity Measure = {\sum }_{i} ( {\sqrt{( {m}_{i} {G}_{1} - {m}_{i} {G}_{2} )}}^{2} \qquad Eqn . B$$

where i is the number of defined patterns, m is the defined pattern or coordinate (e.g., triads) and G1 and G2 correspond to the respective values or numbers of the scenario of interest and the known scenario being compared for the respective defined pattern.

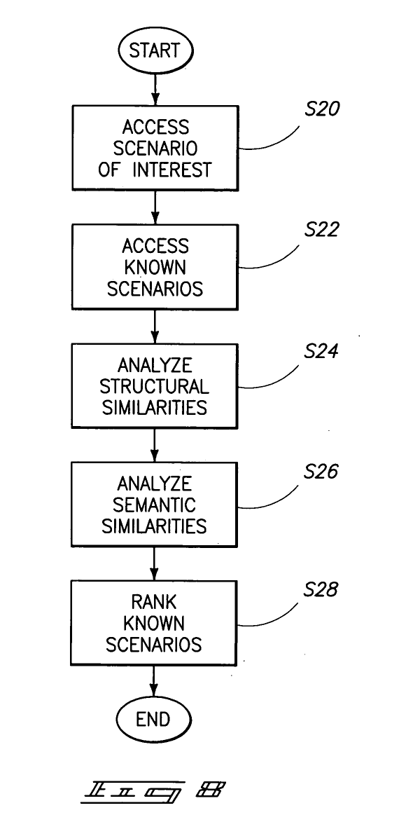

Referring to FIG. 7, computing device 10 may be configured to analyze semantic aspects of labels 36 (e.g., labels 36 shown in the graphical representation 30 of the scenario of FIG. 3 corresponding to nodes or associations of nodes) to analyze a scenario of interest with respect to a plurality of known scenarios according to one embodiment. For example, a plurality of semantic similarity measures may be determined of a scenario of interest with respect to a plurality of known scenarios. The semantic analysis of the scenarios may be performed alone or in addition to above-described structural analysis of the analytical signatures of the scenarios in illustrative scenario analysis embodiments.

FIG. 7 illustrates an exemplary semantic net 60 of a lexical hierarchy. Exemplary lexical hierarchies which may be used include WordNet 1.7 or 2.0 or others. Semantic net 60 of FIG. 7 depicts only a portion of a lexical hierarchy in the form of a rooted tree in the illustrated embodiment. The depicted exemplary semantic net 60 was accessed in 2003 at the WordNet [Web Page], www.cogsci.princeton.edu/-wn/.

The illustrated exemplary semantic net 60 includes a parent group 61, a plurality of subsets 62 and a plurality of elements 64 of one of the subsets 62. A plurality of weights may be assigned to the semantic net 60. In one embodiment, the weights include a weight of “1” between group 61 and a respective subset 62 of the group 61 and a weight of “0.5” between a subset 62 and an element 64 of the subset 62. Other weights may be assigned or used in other embodiments.

Semantic similarities of labels 36 of plural scenarios may be analyzed using semantic net 60. Labels 36 may include content information associated with nodes 32 and edges 34 in graphical representations 30 of scenarios in one embodiment. One semantic analysis method performed by processing circuitry 14 focuses on a case wherein a single word or phrase (i.e., label) is supporting information. Another method focuses on the case wherein a text-block represents the supporting information. Both types of labels 36 are available (simultaneously) in currently available analysis graphical tools. In one embodiment, labels 36 are restricted to individual concepts.

In one embodiment, labels 36 of a scenario may be compared with labels 36 of another scenario. For example, in one analysis embodiment, a plurality of ontological distances may be calculated for a first label 36 of a scenario of interest with respect to the labels 36 of a known scenario. The calculated distances may be summed yielding a semantic similarity value for the first label 36. Thereafter, semantic similarity values may be determined for the remaining labels 36 of the scenario of interest in a similar fashion with respect to the remaining labels 36 of the known scenario. The semantic similarity values may be summed to provide a semantic similarity measure which indicates the relative semantic similarity of the scenarios being analyzed. Semantic similarity measures may be calculated for the scenario of interest relative to the known scenarios in one embodiment. The semantic similarity measures are indicative of semantic similarities of the labels 36 of the scenario of interest with respect to labels 36 of respective ones of the known scenarios in one embodiment.

In other embodiments, individual semantic values may be combined differently to create a semantic similarity measure between collections of nodes of two scenarios. Some candidates for d_{label}(A,B) are:

$${average}_{a ∈ A , a ∈ B} d ( a , b ) {max}_{a ∈ A , a ∈ B} d ( a , b ) {min}_{a ∈ A , a ∈ B} d ( a , b ) \qquad Eqns . C , D , E$$

where d(a,b) is the ontological distances between labels a,b. Additional details are described in Everitt, Brian S., Cluster Analysis. 3^{rd} ed. London: Edward Arnold; 1993, the teachings of which are incorporated herein by reference.

An exemplary distance calculation may be performed on labels 36 to evaluate whether one set of labels 36 is a subset of another as:

$${d}_{tabel} ( A , B ) = {Ave}_{a ∈ A} {min}_{b ∈ B} d ( a , b ) \qquad Eqn . F$$

This measure will be zero when A is a subset of B.

For single word labels, a hypernym structure of WordNet may be used to calculate distances between labels. While the use of WordNet provides the advantage of an existing net, it may also force some limitations on label choices. WordNet provides a net for nouns and verbs but the verb net may be limited (at least compared with the organization available for nouns). Whenever possible, nouns may be selected (e.g., by a user) as labels 36 to provide maximum possible information (e.g., “works for” may be replaced by “employee”). In some cases, such as some proper nouns, labels 36 may not appear in WordNet's lexicon, and no appropriate synonym can be found. In these cases, an appropriate parent for the term may be selected such that the parent is in WordNet's lexicon. For example, a user may make a label “Bob” an element of “male.” In additional examples, a word sense may also be selected by a user or otherwise if multiple senses are available for a label 36. Other hierarchical lexicons other than WordNet may be used in other embodiments.

FIG. 7 illustrates an example of semantic net 60 including supporting information which may be used to account for contents of node and edge labels 36 in graph comparisons in one embodiment. An assumption is that semantic nets used in analysis are a rooted tree. A generic “root” entry may be made a parent of labels 36 which have no existing or natural parents.

The ontological distances for analyzing plural labels 36 of plural scenarios may be calculated in a plurality of ways in exemplary embodiments. In a first determination method, processing circuitry 14 may determine a total ontological distance between the labels 36 being analyzed. For example, for a label 36 of one scenario corresponding to “hired by” and a label 36 of another scenario corresponding to “familial relationships,” a distance of 2.5 would result. According to a second determination method, processing circuitry 14 may take the minimum distance of the two labels 36 being compared to a common root. Referring to the above-example using “hired by” and “familial relationships,” a distance of 1 would result as the smallest distance to the common root (e.g., 1 between “familial relationships” and the common root “human relationships” compared with 1.5 between “hired by” and “human relationships”). Other methods for calculating ontological distances between plural labels 36 may be used in other embodiments. For example, the distances to a common root may be averaged or the maximum distance may be used as opposed to the minimum distance described in the second example above.

In one embodiment, a distance between an element 64 (e.g., “hired by”) and a subset 62 comprising a common root (e.g., “economic relationships”) may be considered to be zero. In addition, a distance between a subset 62 and a group 61 considered to be a common root of the respective subset 62 may also be considered to be zero. The distance between a node and itself may also be considered to be zero in one embodiment.

Additional exemplary details regarding semantic analysis using distance measures are described in Budanitsky, Alexander and Hirst, Graeme, Semantic Distance in WordNet: An experimental, application-oriented evaluation of five measures, North American Chapter of the Association for Computational Linguistics; Pittsburgh, Pa. 2001. http://citeseer.nj.nec.com/budanitsky01semantic.html; Word Net [Web Page]. Accessed 2003 and available at: www.cogsci.princeton.edu/˜wn/, the teachings of both of which are incorporated herein by reference, and the Everitt article incorporated by reference above. For example, some of the finds in the Budanitsky reference suggest that relative frequencies of terms in some broad lexicon may be useful for determining weights of a semantic net.

As mentioned above, the scenario analysis may indicate one of the known scenarios may be more similar or relevant to a scenario of interest compared with another of the known scenarios. In a more specific example, the analysis may rank the similarities of all of the known scenarios with respect to the scenario of interest by the relative similarities of the known scenarios to the scenario of interest. Processing circuitry 14 may utilize structural similarity measures and/or semantic similarity measures to indicate one of the known scenarios is of increased relevance to the scenario of interest compared with another of the known scenarios and/or to rank the similarities of the known scenarios with respect to the scenario of interest in one embodiment.

In an exemplary embodiment which utilizes only one of the structural and semantic similarities, the known scenarios may be ranked from most similar or relevant to least similar or relevant to the scenario of interest by the known scenarios having the smallest structural (or semantic) similarity measures to the scenarios having the largest structural (or semantic) similarity measures, respectively. Other embodiments are possible.

A graphical representation of a scenario may include both structural and content information as described above. To capture both aspects of a scenario, an overall distance between graphs as the sum of the distance between the structural and ontological parts may be used in one embodiment. In an embodiment which analyzes structural and semantic similarities, the respective structural and semantic similarity measures may be combined to provide a combined or overall similarity measure indicative of the relative similarity of the scenarios being analyzed. An exemplary equation to provide a combined similarity measure S_{c} in one embodiment is:

$${S}_{c} = {w}_{1} a + {w}_{2} b \qquad Eqn . G$$

wherein w₁ is a weighting for a structural component, a is the structural similarity measure, w₂ is a weighting for a semantic component and b is the semantic similarity measure. The combination may operate to normalize the structural and semantic similarity measures in a weight averaging method in one embodiment. Normalization of the structural and semantic similarity measures may be implemented in one embodiment by choosing weights according to w₁+w₂=0. The resulting calculated combined similarity measures may be used in one embodiment to rank the known scenarios with respect to the scenario of interest from most relevant to least relevant according to the known scenarios having the smallest combined similarity measures to the largest, respectively, in one embodiment. A user may select the weights w₁ and w₂ in one embodiment to emphasize either structural aspects, semantic aspects or neither in possible implementations.

Following analysis of the scenarios, the processing circuitry 14 may control the display 20 to depict at least one of the known scenarios as more similar or relevant to the scenario of interest compared with another known scenario in one embodiment. In one embodiment, the processing circuitry 14 may control the display 20 to depict a ranking of all of the known scenarios ranked according to the respective similarities with respect to the scenario of interest. An analyst or other user may use the displayed results to assist with analysis of the scenario of interest. For example, the analyst may start with the known scenario indicated to be most relevant and access the respective graphical (or other) representation of the scenario. The analyst may look for similarities between individuals, transactions, communications, places and/or other information of the selected known scenario and the scenario of interest. In addition, the analyst may select graphical representations of additional known scenarios using the ranking in attempts to gain additional information regarding the scenario of interest.

Referring to FIG. 8, an exemplary method for analyzing a first scenario (e.g., scenario of interest) with respect to a plurality of second scenarios (e.g., known scenarios of a database) are shown according to one embodiment. Processing circuitry 14 may be configured to implement the analysis method (e.g., using executable code) in one implementation. The depicted method illustrates structural and semantic analyses operations although only one of structural and semantic analyses may be implemented in other embodiments. Other methods are possible in other embodiments including more, less and/or alternative steps.

Referring to a step S20, the processing circuitry may access a file including data regarding a scenario of interest. The scenario of interest may be provided in the form of a graphical representation, a mathematical (e.g., vector) representation or other representation.

At a step S22, the processing circuitry may access one or more files (e.g., from a database) including data of known scenarios. The known scenarios may be individually provided in the form of a graphical representation, a mathematical (e.g., vector) representation or other representation. Accessing may refer to accessing via communications interface 12, from storage circuitry 16, from user interface 18, generated using processing circuitry 14, or from any other suitable source (not shown) in illustrative embodiments.

If scenarios of steps S20 or S22 are provided in graphical representations, the processing circuitry may execute the method of FIG. 5 to access mathematical representations (e.g., analytical signatures) of the respective scenarios to facilitate comparison operations of the scenarios in one embodiment.

At a step S24, the processing circuitry may analyze the structural similarities of the scenarios in one embodiment. For example, the processing circuitry may compare the mathematical representations of the scenarios in one embodiment.

At a step S26, the processing circuitry may analyze the semantic similarities of the scenarios in one embodiment. For example, the processing circuitry may compare the labels of the scenarios in one embodiment.

At a step S28, the processing circuitry may utilize the outputs of steps S24 and S26 to generate combined structural similarity measures to rank the known scenarios from most to least relevant to the scenario of interest in one embodiment. An analyst may then use the results of the ranking in the described embodiment to select and access graphical and/or other representations of desired scenarios for further analysis.

Although at least some aspects above are described with respect to analysis of a scenario of interest to a plurality of known scenarios, the aspects may also be applied to gauge the similarities of any scenarios with respect to one another or for other purposes in other embodiments.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A scenario analysis method comprising:
accessing a representation of a first scenario;
accessing a plurality of representations of a plurality of second scenarios;
analyzing the representation of the first scenario with respect to the representations of the second scenarios;
providing a plurality of relationships of the representation of the first scenario with respect to respective ones of the representations of the second scenarios responsive to the analyzing; and
ranking the relationships.

2. The method of claim 1 wherein the providing comprises providing the relationships indicative of similarities of respective individual ones of the second scenarios with respect to the first scenario.

3. The method of claim 2 wherein the ranking comprises ranking the relationships according to the respective similarities.

4. The method of claim 2 wherein the similarities are indicative of similarities of structural arrangements of a plurality of nodes of respective individual ones of the representations of the second scenarios with respect to a plurality of nodes of the representation of the first scenario.

5. The method of claim 2 wherein the similarities are indicative of semantic similarities of a plurality of labels of respective individual ones of the representations of the second scenarios with respect to a plurality of labels of the representation of the first scenario.

6. The method of claim 1 wherein the first scenario comprises a scenario of interest being analyzed and the second scenarios are known from a database.

7. The method of claim 1 wherein the representations of the first and second scenarios comprise mathematical representations of structural arrangements of the scenarios.

8. The method of claim 7 wherein the structural arrangements individually comprise a plurality of associations of a plurality of nodes.

9. The method of claim 8 wherein the associations individually comprise an edge intermediate a plurality of the nodes.

10. The method of claim 1 wherein the first scenario comprises information regarding a plurality of people and a plurality of associations of the people.

11. The method of claim 1 wherein the accessings comprise generating the representations of the first and second scenarios.

12. A scenario analysis method comprising:
accessing an initial quantity of information regarding a scenario of interest;
accessing a plurality of known scenarios;
analyzing the scenario of interest with respect to individual ones of the known scenarios using processing circuitry; and
gaining additional information regarding the scenario of interest in addition to the initial quantity of information responsive to the analyzing.

13. The method of claim 12 wherein the accessings comprise accessing representations of the scenario of interest and the known scenarios individually comprising a mathematical representation.

14. The method of claim 12 wherein accessings comprise accessings using processing circuitry.

15. The method of claim 12 wherein the initial quantity of information comprises information regarding an object of the scenario of interest and the gaining additional information comprises gaining additional information regarding the object.

16. The method of claim 12 wherein the analyzing comprises comparing a representation of the scenario of interest with respect to representations of the known scenarios.

17. A scenario analysis device comprising:
processing circuitry configured to access data regarding a scenario of interest, to access respective data regarding a plurality of known scenarios, to analyze the data of the scenario of interest with respect to respective data of individual ones of the known scenarios, and to identify one of the known scenarios as being of increased relevance to the scenario of interest compared with an other of the known scenarios responsive to the analysis.

18. The device of claim 17 wherein the data comprises data regarding structural arrangements of nodes of individual ones of the scenario of interest and the known scenarios, and wherein the processing circuitry is configured to compare numbers of defined patterns of structural arrangements of nodes present in the scenario of interest with respect to numbers of respective defined patterns of structural arrangements of nodes present in individual ones of the known scenarios.

19. The device of claim 18 wherein the processing circuitry is configured to determine similarity measures for respective ones of the known scenarios with respect to the scenario of interest, wherein the similarity measure, for an individual one of the known scenarios, corresponds to a total of the differences of the respective numbers of the individual one of the known scenarios and the scenario of interest.

20. The device of claim 17 wherein the data regarding the scenario of interest and the known scenarios comprises a plurality of mathematical representations.

21. The device of claim 20 wherein the mathematical representations individually comprise information regarding the occurrence of a plurality of defined patterns of nodes in the respective one of the scenario of interest and the known scenarios.

22. The device of claim 21 wherein the defined patterns of nodes comprise different triads individually comprising an arrangement of three nodes.

23. The device of claim 17 wherein the processing circuitry is configured to analyze the data comprising determining semantic similarities of labels of the scenario of interest with respect to labels of individual ones of the known scenarios to provide the identification.

24. A scenario analysis device comprising:
processing circuitry configured to access data regarding a scenario of interest and a plurality of known scenarios, wherein the data comprises information regarding a plurality of labels of the scenario of interest and the known scenarios, wherein the processing circuitry is configured to analyze the labels of the scenario of interest with respect to the labels of the known scenarios to generate a plurality of semantic similarity values indicative of semantic similarities of the labels of the scenario of interest with respect to the labels of the known scenarios.

25. The device of claim 24 wherein the scenario of interest and the known scenarios individually comprise a plurality of objects and association of objects, and the labels comprise labels of the objects and the associations of the objects.

26. The device of claim 24 wherein the scenario of interest and the known scenarios individually comprise a plurality of nodes and association of nodes, and the labels comprise labels of the nodes and the associations of the nodes.

27. The device of claim 24 wherein the processing circuitry is configured, for an individual one of the known scenarios, to sum the semantic similarity values corresponding to the semantic similarities of the labels of the scenario of interest with respect to the labels of the one of the known scenarios to provide a semantic similarity measure indicative of the similarity of the scenario of interest with respect to the one of the known scenarios.

28. The device of claim 27 wherein the processing circuitry is configured to rank the known scenarios using the semantic similarity measures.

29. The device of claim 28 wherein the processing circuitry is configured to generate a plurality of structural similarity measures individually indicative of structural similarities of structural arrangements of nodes of the scenario of interest with respect to an individual one of the known scenarios, and wherein the processing circuitry is configured to rank the known scenarios using the structural similarity measures.

30. The device of claim 29 wherein the processing circuitry is configured, for an individual one of the known scenarios, to weight the respective semantic similarity measure and the structural similarity measure to provide a respective combined similarity measure, and wherein the processing circuitry is configured to rank the known scenarios using the combined similarity measures.

31. The device of claim 24 wherein the processing circuitry is configured to use a lexical hierarchy to generate the semantic similarity values.

32. An article of manufacture comprising:
media comprising programming configured to cause processing circuitry to perform processing comprising:
accessing a first scenario;
accessing a plurality of second scenarios;
analyzing the first scenario with respect to the plurality of second scenarios; and
providing a plurality of similarity measures indicative of similarities of the second scenarios with respect to the first scenario responsive to the analyzing, wherein the similarity measures indicate that one of the second scenarios is of increased similarity to the first scenario compared with the similarity of an other of the second scenarios with respect to the first scenario.

33. The article of claim 32 wherein the first scenario comprises a scenario of interest and the second scenarios comprise known scenarios.

34. The article of claim 32 wherein the media comprises programming configured to cause the processing circuitry to perform the accessings comprising accessing data regarding representations of the first scenario and the second scenarios.

35. The article of claim 34 wherein the representations comprise mathematical representations of structural arrangements of nodes of the scenarios.

36. The article of claim 32 wherein the providing the similarity measures comprises providing the similarity measures indicative of structural similarities of structural arrangements of a plurality of nodes of respective ones of the second scenarios with respect to a plurality of nodes of the first scenario.

37. The article of claim 32 wherein the providing the similarity measures comprises providing the similarity measures indicative of semantic similarities of a plurality of labels of respective ones of the second scenarios with respect to a plurality of labels of the first scenario.

38. A data signal in a transmission medium comprising:
programming configured to cause processing circuitry to perform processing comprising:
accessing data regarding a scenario of interest;
accessing data regarding a plurality of known scenarios;
analyzing the data of the scenario of interest with respect to respective data of individual ones of the known scenarios; and
identifying one of the known scenarios as being of increased relevance to the scenario of interest compared with an other of the known scenarios responsive to the analyzing.

39. The signal of claim 38 wherein the transmission medium comprises a carrier wave.

40. The signal of claim 38 wherein the data of the scenario of interest and the data of the known scenarios individually comprise data regarding a plurality of nodes and associations of the nodes, and wherein the programming is configured to cause the processing circuitry to analyze structural similarities of arrangements of the nodes of the scenario of interest with respect to arrangements of the nodes of individual ones of the known scenarios.

41. The signal of claim 38 wherein the data of the scenario of interest and the data of the known scenarios individually comprise data regarding a plurality of labels, and wherein the programming is configured to cause the processing circuitry to analyze semantic similarities of the labels of the scenario of interest with respect to the labels of individual ones of the known scenarios.
